(19) United States
(12) Patent Application Publication
(10) Pub. No.: US 2013/0183859 A1
(43) Pub. Date: Jul. 18, 2013

(54) CONNECTOR WITH THIN FILM SHIELDING STRUCTURE

(71) Applicant: Nai-Chien CHANG, New Taipei City (TW)

(72) Inventor: Nai-Chien CHANG, New Taipei City (TW)

(21) Appl. No.: 13/723,886

(22) Filed: Dec. 21, 2012

(30) Foreign Application Priority Data
Jan. 12, 2012 (TW) 101200788

(51) Int. Cl. H01R 13/658

(52) U.S. Cl. CPC H01R 13/658
USPC 439/607.01

(57) ABSTRACT

A connector with thin film shielding structure includes an insulation base and an electromagnetic shielding film. The electromagnetic shielding film covers the insulation base, thereby blocking the electromagnetic waves.

This application is based on and claims the benefit of Taiwan Application No. 101200788 filed Jan. 12, 2012 the entire disclosure of which is incorporated by reference herein.

### BACKGROUND

1. Technical Field

The present application relates to a connector, especially to a connector with thin film shielding structure.

2. Related Art

Nowadays, connector is widespread, and the main function of the connector is to be the connecting element for converting or transferring of signal or electricity. In everyday life, the connections between electronic products, such as the connections between the computers and the mouses, or the connections between the music players and the headsets and so on, are all connected by the connectors. However, the electronic product will generate some electromagnetic wave or radiation when in use, or even our living environment has some natural or unnatural electromagnetic wave or radiation as well, such as electric charge in the atmosphere or the radio wave of the wireless access point, etc. However, those useful or useless electromagnetic waves or radiations, no matter directly or indirectly transferred to the connector, can interfere and result in the distortion of the signal which is in transferring or converting by the connector. Therefore, the outside of the connector usually covers a shielding structure to block the interfering of the electromagnetic wave or the radiation.

The conventional connector having the shielding structure mainly includes an insulation base and a metal case. The metal case corresponds and covers to the outer surface of the insulation base. By the material characteristic of the metal case, the electromagnetic wave can be minimized in a way of absorption, reflection, or ground conduction, thereby achieving the effect of blocking the electromagnetic wave or interfering the radiation.

However, the conventional connector with the shielding structure still has the following drawbacks. Since the metal case needs molding, stamping, or other surface processing to be produced, it should cost a lot for the mold and the follow-up processing process. Besides, due to the very limited bending angle and shape of the metal case, the metal case that totally meets the shape of the insulation base can not be produced, and only approximate shape of the metal case can be produced to cover the insulation base. However, there might be special structure design of the insulation base according to different demands, so the metal case might have some natural limitation and can not cover the special structure portion. Therefore, the electromagnetic wave or the radiation can enter the connector through those special structures to interfere the signal in transferring or converting. The aforementioned drawback needs to be improved.

### BRIEF SUMMARY

The present application provides a connector with thin film shielding structure. The electromagnetic waves can be blocked by covering an electromagnetic shielding film over an insulation base.

The connector with thin film shielding structure according to the present application comprises an insulation base and an electromagnetic shielding film, and the electromagnetic shielding film covers the insulation base.

By the electroconductive characteristic of the electromagnetic shielding film, the static electricity inside the connector can be swiftly conducted to the ground circuit via the electromagnetic shielding film to achieve the electrostatic protection effect. Besides, the cost of the molding can be reduced since the electromagnetic shielding film can be produced by other chemical methods. Moreover, the procedure of covering the electromagnetic shielding film over the insulation base is very simple, and thus saves a lot of assembling time.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a first exploded perspective view according to the present application;

FIG. 2 is a second exploded perspective view according to the present application;

FIG. 3 is an assembled sectional view according to the present application;

FIG. 4 is a sectional view of an electromagnetic shielding film according to the present application;

FIG. 5 is an assembled schematic diagram according to the present application; and

FIG. 6 is an operation diagram according to the present application.

### DETAILED DESCRIPTION

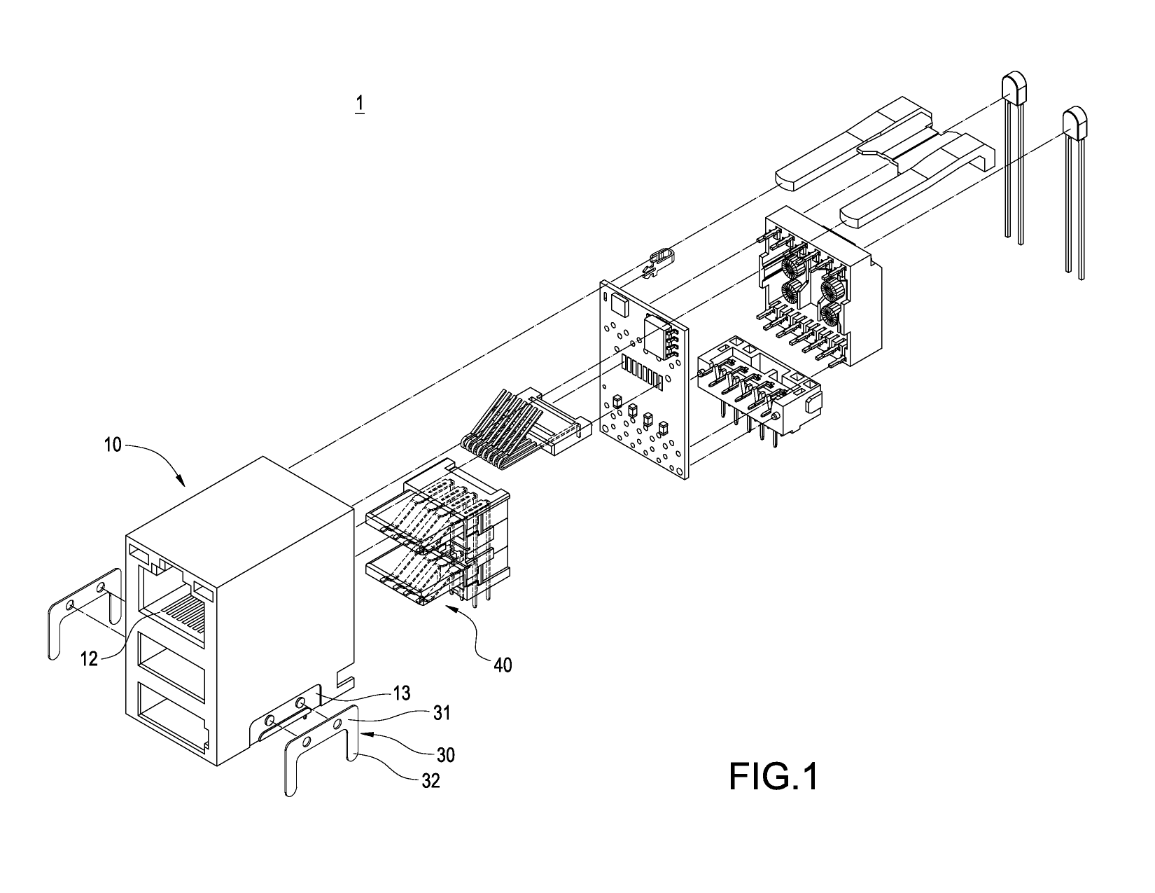

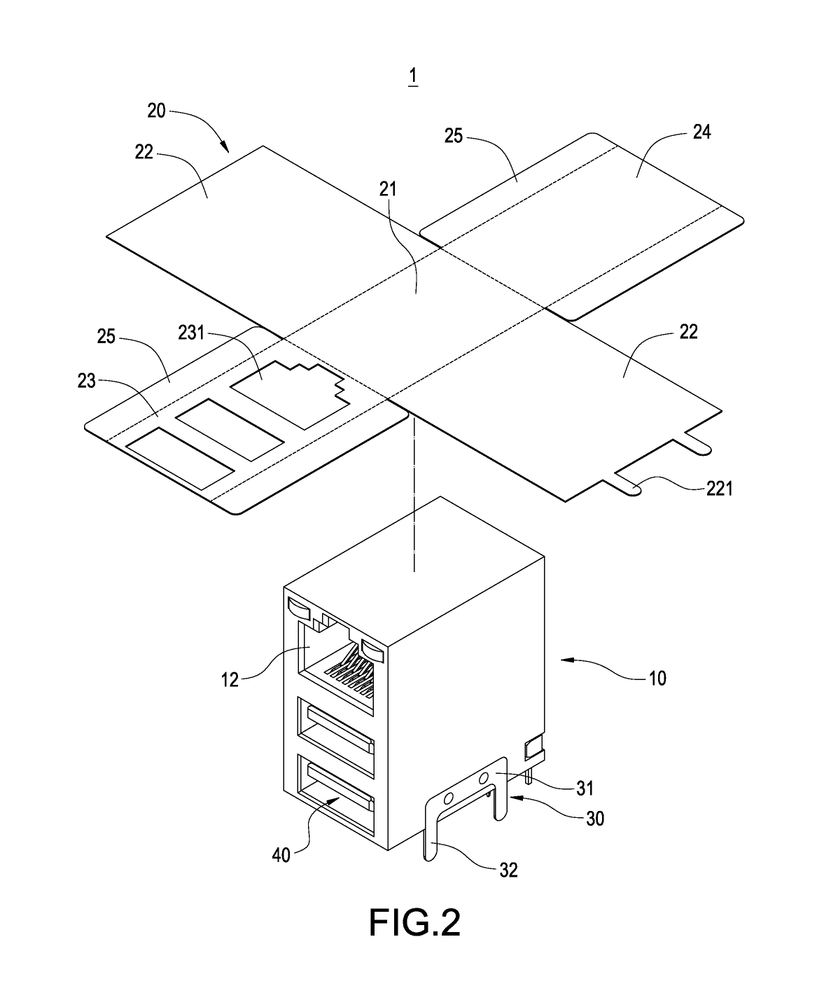

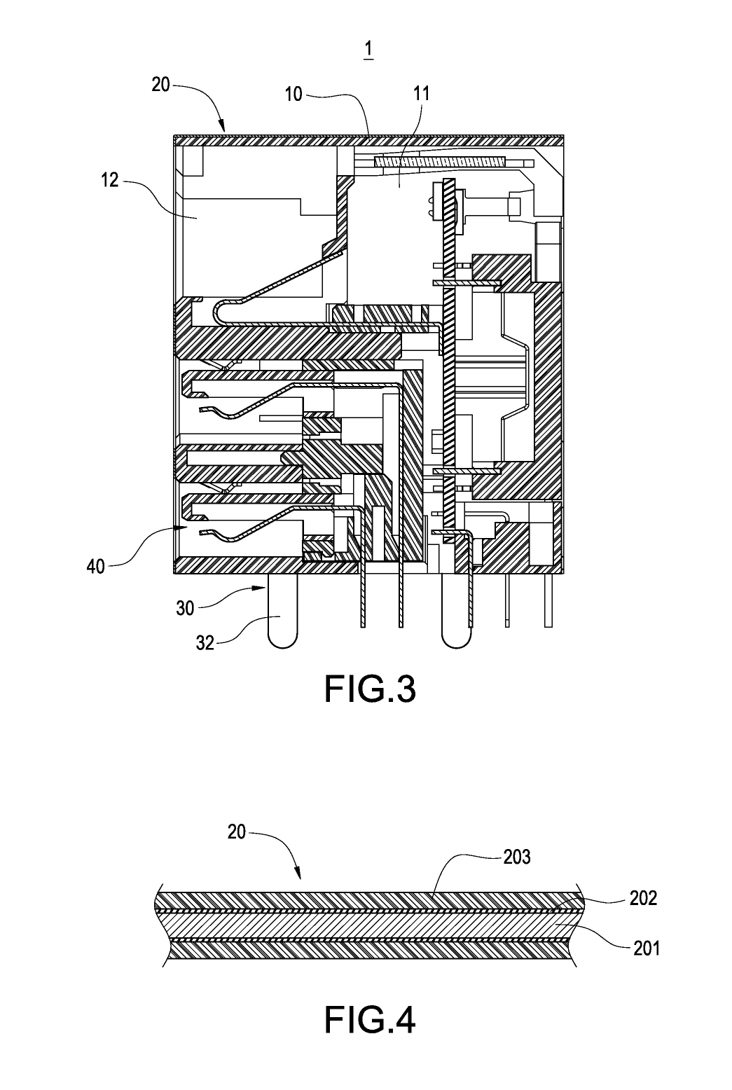

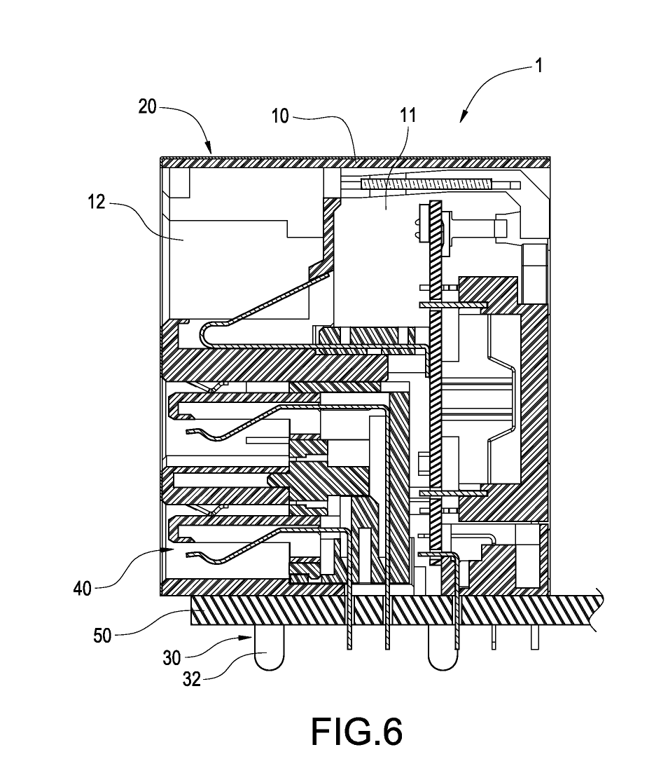

Please refer to FIGS. 1 to 3, the present application provides a connector 1 with thin film shielding structure to electrically connect a motherboard 50 (as shown in FIG. 6) of electronic products, and the connector 1 comprises an insulation base 10 and an electromagnetic shielding film 20.

The insulation base 10 has at least one accommodation space 11 and at least one port 12. The port 12 is formed on one surface of the insulation base 10. At least one side surface of the insulation base 10 is provided with a recess 13, and the insulation base 10 can be made of plastic material.

The electromagnetic shielding film 20 covers the insulation base 10. The electromagnetic shielding film 20 has a top film 21, two side films 22, a front film 23, and a back film 24. One edge of each of the two side films 22, the front film 23 and the back film 24 are adjacent to each edge of the top film 21. The top film 21 corresponds to and covers a top surface of the insulation base 10. At least one of the two side films 22 has a leg 221, and each of the two side films 22 covers each of two side surfaces of the insulation base 10. The front film 23 is provided with an opening 231 corresponding to the port 12 of the insulation base 10. The front film 23 covers a surface where the port 12 is provided on the insulation base 10. The back film 24 covers a surface away from the port 12 of the insulation base 10. Each side edge of the front film 23 and each side edge of the back film 24 extend a folding edge 25, respectively, and each of the folding edges 25 covers corresponding surface of each of the two side films 22.

The connector 1 further comprises at least one conducting element 30 and at least one connecting port 40. The conducting element 30 has a joint 31 corresponding to the recess 13 of the insulation base 10 and at least one fixing leg 32 corresponding to the leg 221 of the side film 22. The joint 31 is embedded in the recess 13. The fixing leg 32 extends and protrudes from the joint 31. The leg 221 covers the fixing leg 32. The fixing leg 32 and the leg 221 are fixed on the motherboard 50 (as shown in FIG. 6). The conducting element 30 is covered by and electrically connected with the electromagnetic shielding film 20, and the conducting element 30 is sandwiched between the electromagnetic shielding film 20 and the insulation base 10.

The connecting port 40 is accommodated in the accommodation space 11 of the insulation base 10 and disposed corresponding to the port 12. The connecting port 40 can be HDMI port, Display port, USB port, TRS port, IEEE port, SATA port, RCA port, or category 5 cable, etc., but not limited thereto. There can be a single connecting port 40, or a plurality of connecting ports 40 stacking or adjacent to each other.

Please refer to FIG. 4, the electromagnetic shielding film 20 according to the present application comprises a conductive thin film 201, an adhesive layer 202 coated on both surfaces of the conductive thin film 201, and a plastic insulation thin film 203 adhesive to both surfaces of the conductive thin film 201 via the adhesive layer 202. The conductive thin film 201 can be made of high conductive metal or high conductive high polymer material, and the adhesive layer 202 can be made of conductive or non-conductive adhesive material.

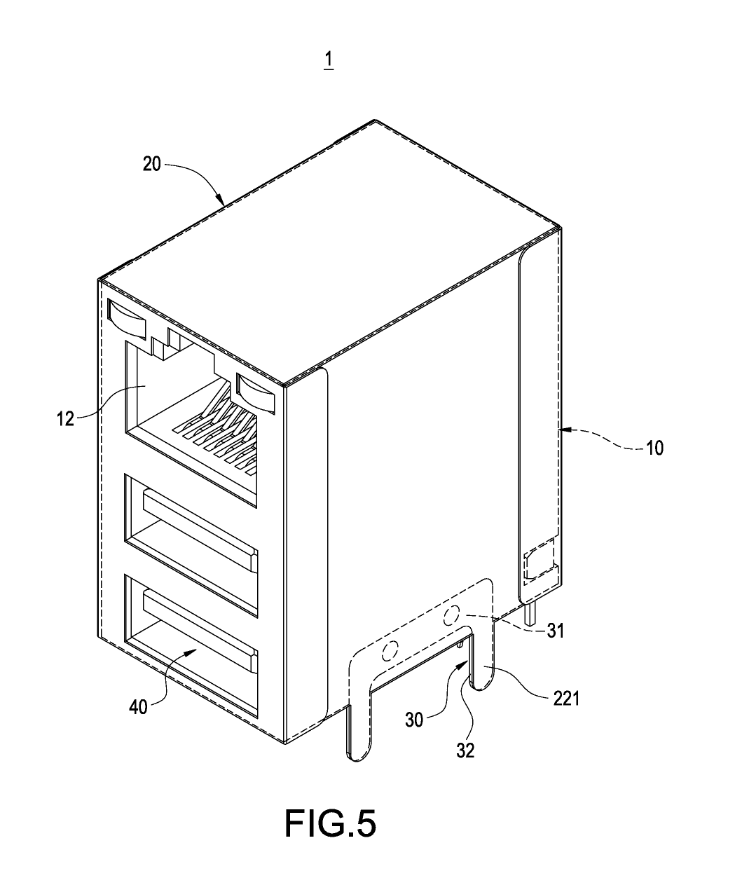

Please refer to FIGS. 5 and 6, when in assembling, the joint 31 of the conducting element 30 is embedded into the recess 13 of the insulation base 10 (as shown in FIG. 1), and then tears away the plastic insulation thin film 203 of one side of the electromagnetic shielding film 20. The electromagnetic shielding film 20 adheres and covers the insulation base 10 via the adhesive layer 202 (as shown in FIG. 4), and thus the conducting element 30 is sandwiched and covered between the electromagnetic shielding film 20 and the insulation base 10, and the conducting element 30 electrically connects the electromagnetic shielding film 20. The connector 1 is fixed on the motherboard 50 by fastening the fixing leg 32 of the conducting element 30 on the motherboard 50.

Since the material of the electromagnetic shielding film 20 is soft and has good plasticity, the electromagnetic shielding film 20 can closely adhere to the insulation base 10, thereby covering a special structure of the insulation base 10 which is hard to be totally covered. By doing so, better covering effect compared to using the conventional metal case can be achieved, and the electromagnetic wave or the radiation transferring to the circuit board of the insulation base 10 through the gap caused by the non-covered special structure of the insulation base 10 can be blocked, thereby increasing the effect of blocking electromagnetic wave or interfering radiation.

Besides, the electromagnetic shielding film 20 has the conductive thin film 201 (as shown in FIG. 4). By the high conductivity of the conductive thin film 201, the static electricity of the connector 1 can be swiftly conducted to the conducting element 30 via the conductive thin film 201. The static electricity can finally be conducted to the motherboard 50 via the conducting element 30 and the conductive thin film 201 covered thereon, and then further conducted to outside of the motherboard 50 via the grounding circuit. By using the connector 1 according to the present application, the speed of the static electricity conduction can be improved to minimize the influence of the static electricity, thereby increasing the protection effect of the static electricity.

Moreover, the electromagnetic shielding film 20 can also be produced by other chemical methods to save the cost of the molding and surface treatment, or other processing. Furthermore, the assembling method of covering the electromagnetic shielding film 20 over the insulation base 10 is very easy, which can save a lot of assembling time as well.

Although the present application has been described with reference to the foregoing preferred embodiments, it will be understood that the application is not limited to the details thereof. Various equivalent variations and modifications can still occur to those skilled in this art in view of the teachings of the present application. Thus, all such variations and equivalent modifications are also embraced within the scope of the application as defined in the appended claims.

What is claimed is:

1. A connector with thin film shielding structure, comprising:
an insulation base; and
an electromagnetic shielding film covering the insulation base.

2. The connector according to claim 1, wherein the electromagnetic shielding film comprises an adhesive layer, and the electromagnetic shielding film is adhered to the insulation base by the adhesive layer.

3. The connector according to claim 2 further comprising at least one conducting element, the conducting element having a joint and at least one fixing leg, the fixing leg extending and protruding from the joint, one side of the insulation base being provided with a recess corresponding to the joint, the joint embedded into the recess, the conducting element electrically connected to and covered by the electromagnetic shielding film, the conducting element sandwiched between the electromagnetic shielding film and the insulation base.

4. The connector according to claim 3, wherein the electromagnetic shielding film comprises a top film, two side films, a front film, and a back film; one edge of each of the two side films, the front film and the back film are adjacent to each edge of the top film, and the electromagnetic shielding film is one-piece integrated.

5. The connector according to claim 4, wherein the top film corresponds to a top surface of the insulation base and covers thereon.

6. The connector according to claim 5, wherein each of the two side films corresponds to each of two side surfaces of the insulation base and covers thereon.

7. The connector according to claim 6, wherein one surface of the insulation base is provided with at least one port, an opening corresponding to the port of the insulation base is provided on the front film, the front film corresponds to and covers the surface having the port of the insulation base.

8. The connector according to claim 7, wherein the back film corresponds to and covers a surface away from the port of the insulation base.

9. The connector according to claim 8, wherein each side edge of the front film and each side edge of the back film extend a folding edge, respectively, and each of the folding edges covers corresponding surface of each of the two side films.

10. The connector according to claim 9 further comprising at least one connecting port, the insulation base further comprising at least one accommodation space, the connecting port accommodated in the accommodation space and disposed corresponding to the port.
